(19) United States
(12) Patent Application Publication
(10) Pub. No.: US 2007/0008211 A1
(43) Pub. Date: Jan. 11, 2007

(54) Vehicle mounted radar apparatus

(75) Inventors: Chiharu Yamano, Tokyo (JP); Yasuyuki Miyake, Aichi-ken (JP)

Correspondence Address: DUANE MORRIS, LLP;IP DEPARTMENT, 30 SOUTH 17TH STREET, PHILADELPHIA, PA, 19103-4196, US

(73) Assignees: DENSO IT LABORATORY, INC.; DENSO CORPORATION

(21) Appl. No.: 11/390,030

(22) Filed: Mar. 27, 2006

(30) Foreign Application Priority Data
Mar. 31, 2005 (JP) 2005-100315

(51) Int. Cl. G01S 13/42; G01S 13/93

(52) U.S. Cl. 342/70; 342/192; 342/196; 342/133; 342/139; 342/146

(57) ABSTRACT

Apparatus has a transmitting antenna for radiating transmitting signals over a scanning range in the shape of a fan for a forward direction of ones own vehicle at a constant transmitting cycle, receiving antennas for receiving reflected waves by a target and for outputting receiving signals, spectrum computing means for computing a frequency complex amplitude spectrum from the receiving and transmitting signals, advancing direction computing means for computing an advancing direction of ones own vehicle, advancing direction element extracting means for extracting directional elements corresponding to the advancing direction from the frequency complex amplitude spectrum on the basis of the obtained advancing direction, and for outputting computed result data, distance-azimuth spectrum computing means for computing a distance-azimuth spectrum of ones own vehicle, and target detecting means for detecting the target which exists in a forward direction of ones own vehicle on the basis of the computed distance-azimuth spectrum.

### BACKGROUND OF THE INVENTION

This invention relates to an electron scanning type of a vehicle-mounted radar apparatus which is used for detecting a preceding target which exists in a forward direction.

A conventional vehicle-mounted radar apparatus for control on an inter-vehicle distance generally obtains a distance to a target and an azimuth as shown in a patent-related document 1 (will be mentioned later) in such a way that with an electron scanning type of radar, electromagnetic waves, such as millimetric waves, are radiated in order to obtain a distance to a target, such as a preceding vehicle which exists in a forward direction, and an azimuth, and two or more antennas receive reflected waves of the electromagnetic waves which have been reflected by a target, and an arithmetic processing is implemented on received signals with a well-known method, such as a distance spectrum conversion and an azimuth spectrum conversion.

Generally, radar art has the following problems.

1. A scanning range of transmitting radio waves in lateral (horizontal) direction is a fan shape due to the radiation characteristic thereof. Then, the energy is dispersed with the distances, and the power level of the reflected wave from a target attenuates with the distance to a target. If the reflected wave is widely attenuated and the signal level of the reflected wave is lower than the noise level of a system, it is impossible to detect the reflected wave. Then, the distance range where targets can be detected is limited.

2. When using a high resolution azimuth spectrum conversion processing (MUSIC) as means for detecting azimuth, a performance of the resolved azimuth (angular error or resolution) is known to depend on a S/N ratio (signal-to-noise ratio) of the reflected wave to be inputted, and the further a distance to a target is, the lower the S/N ratio of a reflected wave therefrom is.

[Patent-related document 1] Japanese patent application, publication number of which is 2001-228239]

Besides, it is predicted that the vehicle-mounted radar apparatus catches more unnecessary reflected waves (non-desired waves) which are reflected from targets excluding the vehicle traveling lane although the range which is subject for detection is vehicle traveling lane, such as a road. This leads to deterioration of the detection accuracy of the target which exists in the range to be detected. Especially, the percentage of the range excluding one where vehicles run is high in the scanning range with a radar apparatus with the distance from the radar apparatus. Then, the degree of entering non-desired waves is relatively high. For this reason, it is difficult to detect the target on the range where vehicles run which is far from the radar apparatus.

The present invention can provide an electron scanning type of a vehicle-mounted radar apparatus for accurately detecting the preceding target which exists in a vehicle lane for overcoming the above-mentioned inconvenience.

### BRIEF DESCRIPTION OF THE DRAWINGS

FIG. 1 is a block diagram showing an instance of a vehicle-mounted radar apparatus; and

FIG. 2 is a view exemplarily showing a control for forming beams in a scanning range and a vehicle lane range of the vehicle-mounted radar apparatus.

### SUMMARY OF THE INVENTION

One aspect of the invention is vehicle-mounted radar apparatus, comprising:

a transmitting antenna for radiating transmitting signals as electromagnetic waves over a scanning range in the shape of a fan for a forward direction of ones own vehicle at a constant transmitting cycle;

two or more receiving antennas for respectively receiving reflected waves of said electromagnetic waves which are reflected by a target and for respectively outputting receiving signals;

spectrum computing means for computing a frequency complex amplitude spectrum in said scanning range from said receiving signals and said transmitting signals;

advancing direction computing and obtaining means for computing and obtaining an advancing direction of said ones own vehicle;

advancing direction element extracting means for computing and extracting directional elements in the bounds corresponding to said advancing direction from said frequency complex amplitude spectrum in said scanning range on the basis of said advancing direction which has been computed and obtained, and for outputting computed result data;

distance-azimuth spectrum computing means for computing a distance-azimuth spectrum of said ones own vehicle on the basis of said computed result data; and

target detecting means for detecting said target which exists in a forward direction of said ones own vehicle on the basis of said computed distance-azimuth spectrum.

According to this aspect of the invention, the directional elements corresponding to the advancing direction of ones own vehicle which is obtained by the advancing direction computing and obtaining means are computed and selectively extracted from the frequency complex amplitude spectrum in the scanning range, so that the receiving signal elements of the directions excluding the direction corresponding to the advancing direction of ones own vehicle can be effectively restricted, thereby improving the S/N ratio of the receiving signal. In the result, the resolution azimuth performance of the distance-azimuth spectrum can be improved, and it is possible to provide the accurate vehicle-mounted radar apparatus.

Another aspect of the invention is the vehicle-mounted radar apparatus, wherein said advancing direction computing and obtaining means has vehicle lane range setting means for setting a vehicle lane range having a predetermined angular range with said obtained advancing direction as its center, and said advancing direction element extracting means computes and extracts directional elements in the bounds corresponding to said advancing direction from said frequency complex amplitude spectrum in said scanning range on the basis of said set vehicle lane range.

According to this aspect of the invention, the directional elements of the bounds corresponding to the advancing direction of the frequency complex amplitude spectrum are computed and extracted on the basis of the vehicle lane range which is set with the advancing direction as its center, so that the distance-azimuth spectrum wherein the signals in the range corresponding to the vehicle lane range where ones own vehicle advances, such as a road, are emphasized can be obtained, thereby providing the accurate vehicle-mounted radar apparatus.

Besides, another aspect of the invention is the vehicle-mounted radar apparatus, wherein said advancing direction computing and obtaining means has handle steering angle detecting means for detecting a steering angle of a handle of said ones own vehicle, and advancing direction computing means for computing said advancing direction of said ones own vehicle on the basis of said detected handle steering angle.

According to this aspect of the invention, the advancing direction of ones own vehicle can be computed from the steering angle of a handle, so that the correct advancing direction can be computed with a simple structure.

Besides, another aspect of the invention is the vehicle-mounted radar apparatus, wherein said advancing direction computing and obtaining means has vehicle lane image obtaining means for obtaining an image of the front of said vehicle lane on which said ones own vehicle runs, and advancing direction computing means for computing said advancing direction of said ones own vehicle on the basis of a relative position of said ones own vehicle to said obtained image of said front of said vehicle lane.

According to this aspect of the invention, the advancing direction can be computed from the image of the front of the vehicle lane where ones own vehicle runs, thereby obtaining the advancing direction, taking the actual road situation into consideration.

Besides, another aspect of the invention is the vehicle-mounted radar apparatus, wherein said advancing direction computing and obtaining means has data obtaining means for obtaining road location data which shows a plane location state of a road on which said ones own vehicle is presently running and a present position of said ones own vehicle, and advancing direction computing means for computing said advancing direction of said ones own vehicle on the basis of said obtained road location data and said present position of said ones own vehicle.

According to this aspect of the invention, the advancing direction is computed from the road location data which shows the plane location situation of the road on which ones own vehicle is presently runs and the present position of ones own vehicle, so that an existent car navigation unit which is mounted on ones own vehicle can be utilized.

Another aspect of the invention is the vehicle-mounted radar apparatus, wherein said advancing direction computing and obtaining means has road facility obtaining means for computing and obtaining information on a road facility which is arranged on said vehicle lane on which said ones own vehicle runs on the basis of a search signal with a radar, and advancing direction computing means for computing a curvature of said road from said obtained information on road facility and for computing said advancing direction of said ones own vehicle.

According to this aspect of the invention, the advancing direction of ones own vehicle is computed in such a way that the information on road facility is obtained on the basis of the already obtained search signals of the radar, and the curvature of the road is computed from the information, so that the advancing direction of ones own vehicle can be easily computed without a specific unit for obtaining the advancing direction of ones own vehicle, such as a car navigation unit.

### DESCRIPTION OF THE PREFERRED EMBODIMENTS

An embodiment of the invention will now be explained, referring to appended drawings.

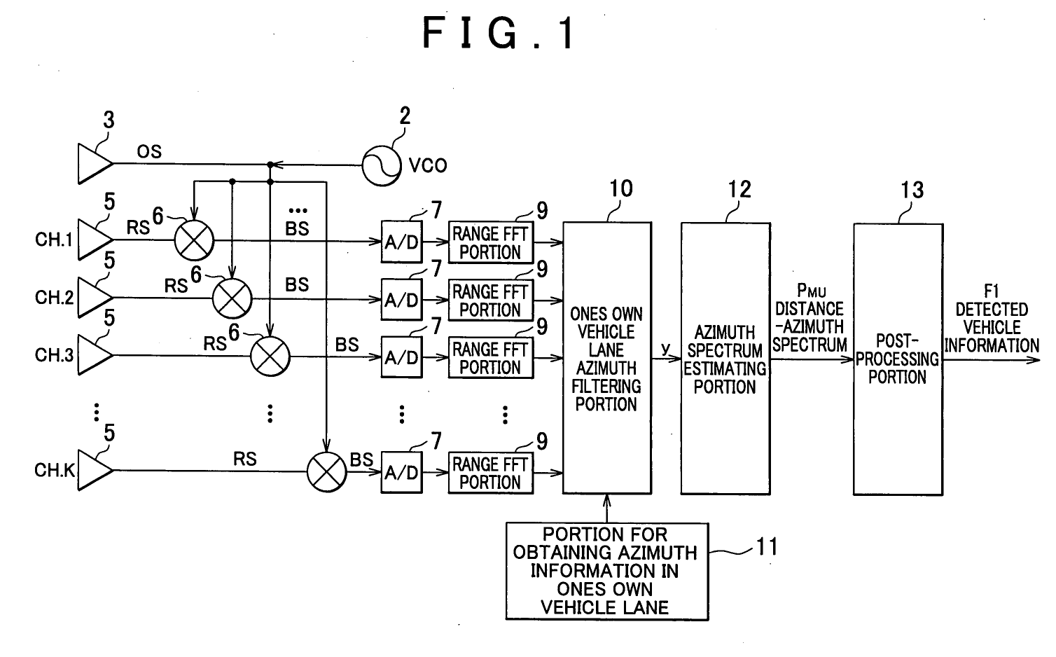

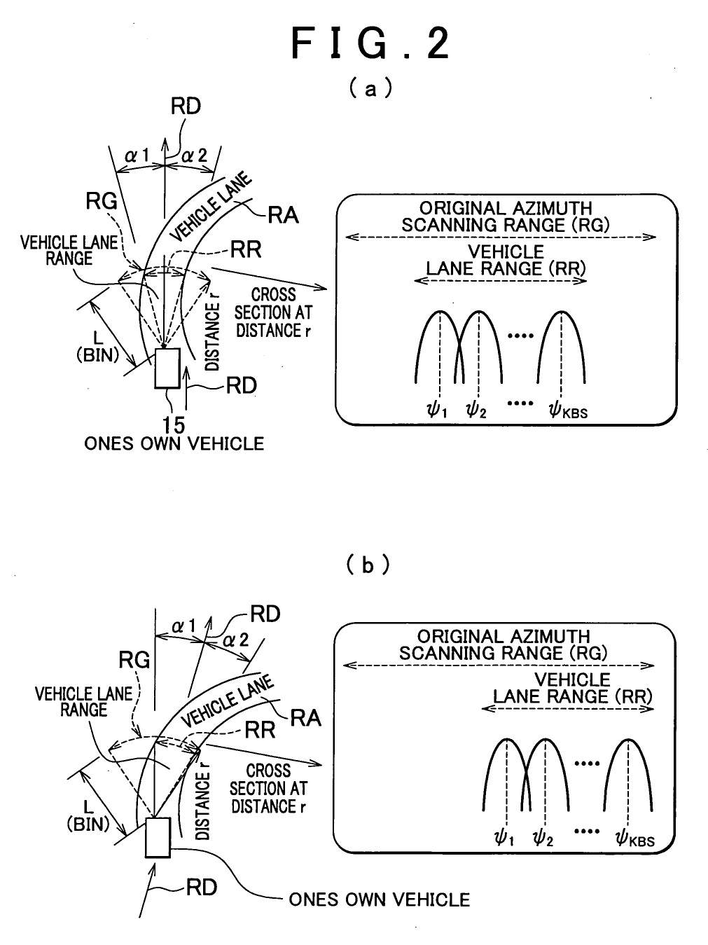

FIG. 1 is a block diagram showing an instance of a vehicle-mounted radar apparatus, and FIG. 2 is a view exemplarily showing a control for forming beams in a scanning range and a vehicle lane range of the vehicle-mounted radar apparatus.

As shown in FIG. 1, a vehicle-mounted radar apparatus 1 has a voltage controlled oscillator (VCO) 2, and a transmitting antenna 3 is connected with the oscillator 2. And, the vehicle-mounted radar apparatus has K numbers of receiving antennas 5 which are comprised of K channels, and the K numbers of these receiving antennas 5 comprise an array antenna. A mixer 6 connected with the oscillator 2 is connected with each receiving antenna 5. A range FFT (Fast Fourier Transform) portion 9 is connected with the mixer 6 through an A/D converter 7.

A ones own vehicle lane azimuth filtering portion 10 is connected with each range FFT portion 9, and a portion for obtaining azimuth information in ones own vehicle lane 11 and an azimuth spectrum estimating portion 12 are connected with the ones own vehicle lane azimuth filtering portion 10. A post-processing portion 13 for implementing an arithmetic processing, such as the processing for detecting a preceding vehicle by tracking the vehicle with a passage of time, is connected with the azimuth spectrum estimating portion 12. Since the detailed processing which the post-processing portion 13 implements is a known art, details of which is described in the Japanese patent application (pubulication No. 2003-270341), the explanation thereof is omitted in the specification.

The vehicle-mounted radar apparatus 1 has the above-mentioned structure. The oscillator 2 outputs a modulated wave to the transmitting antenna 3 as a transmitting signal OS by a controlled voltage which is outputted from a DC power for modulation (not shown), and the transmitting signal OS is radiated over a scanning range RG in the shape of a fan for the forward direction of a ones own vehicle 15 having the vehicle-mounted radar apparatus 1 of FIG. 2(a) from the transmitting antenna 3 as an electromagnetic wave at a predetermined transmitting cycle. A part of the transmitting signals OS is outputted to a mixer 42 which is connected with each antenna 3.

The transmitting signals OS which were radiated from the transmitting antenna 3 are reflected by targets, such as preceding vehicles and walls, which exist within the predetermined range RG in the forward direction of the ones own vehicle 15, and the reflected waves are radiated into the K numbers of the receiving antennas 5. A transmitting signal RS of a channel of K numbers of the channels, respectively corresponding to the K numbers of the receiving antennas 5, is outputted from each receiving antenna 5 to the mixer 6. A part of the transmitting signals OS is mixed in the mixer 6, and the K channels of beat signals BS which are differential signals between the transmitting signals OS and the receiving signals RS are respectively outputted to the A/D converters 7. Since the detailed processing for obtaining the beat signal BS on the basis of the receiving signal RS and the transmitting signal OS is a known art, details of which is mentioned in a Japanese patent application (publication No. H11-133142), its explanation is omitted in the specification.

The A/D converter 7 converts the beat signal BS which is an analog signal into a digital signal having a sampling frequency Fs and a quantized bit number q. The K channels of the digitized beat signals BS are extracted as M numbers of sampling data for each receiving antenna 5 every transmitting cycle of the transmitting signals OS (snapshot), and the data are respectively stored in a memory (not shown). Then, K×M numbers of the digital data are stored per snapshot in the memory as the sampling data.

The data of one snapshot can be represented with Expression (1).

$$\begin{matrix}[ Expression 1 ] & \\ U [ n ] ( \begin{matrix}{u}_{11} [ n ] & {u}_{12} [ n ] & & {u}_{1 M} [ n ] \\ {u}_{21} [ n ] & {u}_{22} [ n ] & & \\ & & ⋰ & \\ {u}_{K 1} [ n ] & {u}_{K 2} [ n ] & & {u}_{KM} [ n ]\end{matrix} ) & ( 1 )\end{matrix}$$

where n=1, 2 . . . denotes a snapshot number which shows the order of the snapshots.

Thus obtained channel data (Expression 2) of each channel corresponding to each receiving antenna 5 is inputted in the corresponding range FFT portion 9, and a beat frequency amplitude spectrum (Expression 3) is computed by the discrete Fourier transform.
(uₖ₁[n] uₖ₂[n] . . . u_{kM}[n]) [Expression 2]
(xₖ₁[n] xₖ₂[n] . . . xₖₘ[n]) [Expression 3]

Then, K numbers of channels of beat frequency complex amplitude spectra X[n] are represented as a matrix as shown with Expression (2).

$$\begin{matrix}[ Expression 4 ] & \\ X [ n ] ( \begin{matrix}{x}_{11} [ n ] & {x}_{12} [ n ] & & {x}_{1 Nr} [ n ] \\ {x}_{21} [ n ] & {x}_{22} [ n ] & & \\ & & ⋰ & \\ {x}_{K 1} [ n ] & {x}_{K 2} [ n ] & & {x}_{KNr} [ n ]\end{matrix} ) & ( 2 )\end{matrix}$$

A window function may be multiplied if necessary at the time of the discrete Fourier transform. The range FFT portion 9 implements zero padding in the fast Fourier transform processing so that the number of distance-direction spectra can be Nr in Expression (2).

The K channels of the thus obtained beat frequency complex amplitude spectra are outputted to the ones own vehicle lane azimuth filtering portion 10.

As shown in FIG. 2, the portion for obtaining azimuth information in ones own vehicle lane 11 computes and obtains an advancing direction in which the ones own vehicle 15 shall advance from now on. In order to do so, various kinds of method are used. Concretely speaking, the advancing direction RD in which ones own vehicle shall advance from now on is computed from information on a handle steering angle of ones own vehicle 15 which is obtained through means for detecting handle steering angle (not shown).

Otherwise, the advancing direction RD is computed by computing a position of a vehicle lane RA which exists in the forward direction of ones own vehicle 15 relative to ones own vehicle on the basis of an image of the vehicle lane RA, such as a road, which is obtained with a vehicle-mounted camera which is mounted on ones own vehicle 15. Alternatively, the advancing direction RD which ones own vehicle 15 shall advance from now on is computed by computing and obtaining road location data which shows a plane location state of a road on which ones own vehicle 15 is now running and the present position of ones own vehicle 15 in a car navigation unit which is mounted on ones own vehicle 15, and by referring to the obtained result. The portion for obtaining azimuth information in ones own vehicle lane 11 computes and sets a range in the shape of a fan, having predetermined angular ranges α1, α2 in both right and left advancing directions of the ones own vehicle 15 with the computed advancing direction RD as its center as a vehicle lane range RR. In this case, the vehicle lane range RR is set so as to be included within the scanning range RG of the transmitting signals OS from the transmitting antennas 3.

Besides, the portion for obtaining azimuth information in ones own vehicle lane 11 may be provided with road facility obtaining means for implementing proper signal processing on the K channels of the beat frequency complex amplitude spectra to be outputted from the range FFT portion 9 or for obtaining information on road facility which is located on the vehicle lane RA on which ones own vehicle is running, such as guard rails, on the basis of a search signal with a radar which is obtained with separately provided radar means, and advancing direction computing means for computing a road curvature from the information on the shape of the road facility which is obtained by the road facility obtaining means and for computing the advancing direction RD which ones own vehicle 15 shall advance from now on from the result of the road curvature.

The angular ranges α1, α2 are properly set so as to include the vehicle lane, such as a road, which exists a predetermined distance L away from ones own vehicle 15 in the forward direction. Fixed values may be used as the angular ranges α1, α2, and the width of the vehicle lane RA may be computed and set, fitting the width of the vehicle lane range RA which is obtained from the road location data which is held in a vehicle-mounted camera or a car navigation unit. The angular ranges α1, α2 may be equal to each other, or may be different from each other.

The vehicle lane range RR which is computed and set by the portion for obtaining azimuth information in ones own vehicle lane 11 is outputted to the ones own vehicle lane azimuth filtering portion 10. The ones own vehicle lane azimuth filtering portion 10 implements a filtering processing for leaving directional elements inside the vehicle lane range RR and restricting the other directional elements in the scanning range RG on the K channels of the beat frequency complex amplitude spectra X[n] which are inputted from the range FFT portion 9 every distance BIN from each transmitting antenna 3 on the basis of the vehicle lane range RR in the scanning range RG of ones own vehicle which has been outputted from the portion for obtaining azimuth information in ones own vehicle lane 11. In other words, the directional elements in the vehicle lane range RR are extracted from the K channels of the beat frequency complex amplitude spectra X[n] in the scanning range RG. In this case, the operation volume can be decreased and the processing speed can be improved by setting the distance BIN on which the filtering processing is implemented as a constant bounds.

Concretely speaking, a beam space matrix B_{M} in the distance BIN from ones own vehicle 15 to the scanning range RG in the snapshot number n at a point of time is computed as shown in Expression (3).

$$\begin{matrix}[ Expression 5 ] & \\ {B}_{M} [ n , r ] = \frac{1}{\sqrt{K}} ( \begin{matrix}exp ( - j \frac{K - 1}{2} {ψ}_{1} ) & exp ( - j \frac{K - 1}{2} {ψ}_{2} ) & ⋯ & exp ( - j \frac{K - 1}{2} {ψ}_{BS} ) \\ exp ( - j \frac{K - 3}{2} {ψ}_{1} ) & exp ( - j \frac{K - 3}{2} {ψ}_{2} ) & ⋯ & exp ( - j \frac{K - 3}{2} {ψ}_{BS} ) \\ ⋮ & ⋮ & ⋰ & ⋮ \\ exp ( j \frac{K - 3}{2} {ψ}_{1} ) & exp ( j \frac{K - 3}{2} {ψ}_{2} ) & ⋯ & exp ( j \frac{K - 3}{2} {ψ}_{BS} ) \\ exp ( j \frac{K - 1}{2} {ψ}_{1} ) & exp ( j \frac{K - 1}{2} {ψ}_{2} ) & ⋯ & exp ( j \frac{K - 1}{2} {ψ}_{BS} )\end{matrix} ) & ( 3 )\end{matrix}$$

wherein Ψk (k=1, 2, . . . K_{BS}) denotes a central direction (the maximum sensing direction) of the beam which is formed by each column vector of the beam space matrix B_{M} as shown in FIG. 2, and K_{BS} denotes the number of two or more beams to be selected which is set so as to be K_{BS}<K. The ones own vehicle lane azimuth filtering portion 10 controls Ψₖ and a method of selecting two or more beams so as to correspond the bounds in the sensing direction which is formed by the beam space matrix B_{M} to the vehicle lane range RR which is computed and set by the portion for obtaining azimuth information in ones own vehicle lane 11 in the scanning range RG as shown in FIG. 2(a) (b).

When thus multiplying the computed beam space matrix Bₘ[n,r] by the beat frequency complex amplitude spectrum X[n] as shown in Expression (4) the random signal elements from the range excluding the vehicle lane range RR are restricted from the beat frequency complex amplitude spectrum x[n], thereby obtaining the data y where signal-to-noise ratio (SNR) is improved.

$$\begin{matrix}[ Expression 6 ] & \\ ( \begin{matrix}{y}_{1 r} [ n ] \\ {y}_{2 r} [ n ] \\ ⋮ \\ {y}_{{K}_{BSr}} [ n ]\end{matrix} ) = {B}_{M}^{H} [ n , r ] \cdot ( \begin{matrix}{x}_{1 r} [ n ] \\ {x}_{2 r} [ n ] \\ ⋮ \\ {x}_{Kr} [ n ]\end{matrix} ) & ( 4 )\end{matrix}$$

In Expression (4), H denotes a hermitian transpose of the matrix.

Then, the signal elements in the vehicle lane range RR where ones own vehicle 15 is advancing are extracted in the scanning range RG where the transmitting signals OS are scanned, as shown in FIG. 2. The methods of extracting the signals in the vehicle lane range RR of ones own vehicle 15 from the beat frequency complex amplitude spectrum X[n] are a method of operating a produced projection matrix, a method of utilizing a result of a digital beam-forming by obtaining the beat signal BS from the transmitting signal OS and the receiving signal RS and the like, in addition to the above-mentioned method with the beam space matrix.

The thus obtained data y is outputted to the azimuth spectrum estimating portion 12. The azimuth spectrum estimating portion 12 produces a special correlation matrix Ry every each distance BIN with Expression (5). In Expression (5), H denotes a hermitian transpose of the matrix. And, N_{SSN} denotes the number of the snapshots which are utilized for the operation. (reference document: “Adaptive signal processing in array antenna” written by Nobuo KIKUMA)

$$\begin{matrix}[ Expression 7 ] & \\ Ry [ r ] = \frac{1}{{N}_{SSN}} {\sum }_{n = 1}^{{N}_{SSN}} ( \begin{matrix}{y}_{1 r} [ n ] \\ {y}_{2 r} [ n ] \\ ⋮ \\ {y}_{{K}_{BSr}} [ n ]\end{matrix} ) \cdot {( \begin{matrix}{y}_{1 r} [ n ] \\ {y}_{2 r} [ n ] \\ ⋮ \\ {y}_{{K}_{BSr}} [ n ]\end{matrix} )}^{H} & ( 5 )\end{matrix}$$

A distance-azimuth spectrum P_{MU} on the thus obtained special correlation matrix Ry is obtained with a well-known method, such as the MUSIC method, and the computed result is outputted to the post-processing portion 13. Concretely speaking, an eigenvalue expansion is implemented on the space correlation matrix Ry so as to extract an eigenvector of a noise subspace, and Na numbers of MUSIC pseudo spectra in the azimuth direction are obtained as the distance-azimuth spectrum P_{MU}, utilizing the eigenvector of the noise subspace, as shown in Expression (6). This method is a well-known method. In order to compute the distance-azimuth spectrum P_{MU}, the other well-known high resolution methods may be used (reference document: Japanese patent application, publication number of which is 2003-270341).

$$\begin{matrix}[ Expression 8 ] & \\ {P}_{MU} = ( \begin{matrix}{p}_{11} & {p}_{12} & & {p}_{1 Nr} \\ {p}_{21} & {p}_{22} & & \\ & & ⋰ & \\ {p}_{Na 1} & {p}_{Na 2} & & {p}_{NaNr}\end{matrix} ) & ( 6 )\end{matrix}$$

The thus obtained distance-azimuth spectrum P_{MU} is outputted to the post-processing portion 13 of FIG. 1. The post-processing portion 13 implements a well-known tracking processing with a passage of time, and computes and detects the target, such as a preceding vehicle existing in the forward direction of ones own vehicle 15, and the computed is outputted as detected vehicle information F1.

The invention can be utilized as a vehicle-mounted radar apparatus for detecting an existence of a preceding vehicle existing in a forward direction by mounting on a vehicle.

The present invention has been explained on the basis of the example embodiments discussed. Although some variations have been mentioned, the embodiments which are described in the specification are illustrative and not limiting. The scope of the invention is designated by the accompanying claims and is not restricted by the descriptions of the specific embodiments. Accordingly, all the transformations and changes within the scope of the claims are to be construed as included in the scope of the present invention.

1. Vehicle-mounted radar apparatus, comprising:
a transmitting antenna for radiating transmitting signals as electromagnetic waves over a scanning range in the shape of a fan for a forward direction of ones own vehicle at a constant transmitting cycle;
two or more receiving antennas for respectively receiving reflected waves of said electromagnetic waves which are reflected by a target and for respectively outputting receiving signals;
spectrum computing means for computing a frequency complex amplitude spectrum in said scanning range from said receiving signals and said transmitting signals;
advancing direction computing and obtaining means for computing and obtaining an advancing direction of said ones own vehicle;
advancing direction element extracting means for computing and extracting directional elements in the bounds corresponding to said advancing direction from said frequency complex amplitude spectrum in said scanning range on the basis of said advancing direction which has been computed and obtained, and for outputting computed result data;
distance-azimuth spectrum computing means for computing a distance-azimuth spectrum of said ones own vehicle on the basis of said computed result data; and
target detecting means for detecting said target which exists in a forward direction of said ones own vehicle on the basis of said computed distance-azimuth spectrum.

2. The vehicle-mounted radar apparatus according to claim 1, wherein said advancing direction computing and obtaining means has vehicle lane range setting means for setting a vehicle lane range having a predetermined angular range with said obtained advancing direction as its center, and said advancing direction element extracting means computes and extracts directional elements in the bounds corresponding to said advancing direction from said frequency complex amplitude spectrum in said scanning range on the basis of said set vehicle lane range.

3. The vehicle-mounted radar apparatus according to claim 1, wherein said advancing direction computing and obtaining means has handle steering angle detecting means for detecting a steering angle of a handle of said ones own vehicle, and advancing direction computing means for computing said advancing direction of said ones own vehicle on the basis of said detected handle steering angle.

4. The vehicle-mounted radar apparatus according to claim 1, wherein said advancing direction computing and obtaining means has vehicle lane image obtaining means for obtaining an image of the front of said vehicle lane on which said ones own vehicle runs, and advancing direction computing means for computing said advancing direction of said ones own vehicle on the basis of a relative position of said ones own vehicle to said obtained image of said front of said vehicle lane.

5. The vehicle-mounted radar apparatus according to claim 1, wherein said advancing direction computing and obtaining means has data obtaining means for obtaining road location data which shows a plane location state of a road on which said ones own vehicle is presently running and a present position of said ones own vehicle, and advancing direction computing means for computing said advancing direction of said ones own vehicle on the basis of said obtained road location data and said present position of said ones own vehicle.

6. The vehicle-mounted radar apparatus according to claim 1, wherein said advancing direction computing and obtaining means has road facility obtaining means for computing and obtaining information on a road facility which is arranged on said vehicle lane on which said ones own vehicle runs on the basis of a search signal with a radar, and advancing direction computing means for computing a curvature of said road from said obtained information on road facility and for computing said advancing direction of said ones own vehicle.
